(19) United States
(12) Patent Application Publication
(10) Pub. No.: US 2014/0108783 A1
(43) Pub. Date: Apr. 17, 2014

(54) VIRTUAL NETWORK BUILDING SYSTEM, VIRTUAL NETWORK BUILDING METHOD, SMALL TERMINAL, AND AUTHENTICATION SERVER

(71) Applicant: UKD Company Limited, Kanagawa (JP)

(72) Inventors: Toru SUZUKI, Kanagawa (JP); Hideki WATANABE, Kanagawa (JP)

(73) Assignee: UKD Company Limited, Kanagawa (JP)

(21) Appl. No.: 14/055,858

(22) Filed: Oct. 16, 2013

(30) Foreign Application Priority Data
Oct. 16, 2012 (JP) 2012-229236

(51) Int. Cl. H04L 29/06; H04L 9/06

(52) U.S. Cl. CPC H04L 63/0876; H04L 9/06
USPC 713/155

(57) ABSTRACT

A virtual network building system includes a small terminal and an authentication server. The small terminal includes an identifier transmission unit automatically transmitting an identifier to the authentication server via a client terminal in a state in which a connection unit is connected to the client terminal, and is attachable to and detachable from the client terminal. The authentication server includes an authentication unit performing authentication on the basis of the identifier of the small terminal, a distribution unit distributing software for encrypting communication to the client terminal according to selected communication protocol and encryption method, a reception unit receiving information (access request information) regarding a request for access to the target apparatus, which is automatically transmitted from the distributed software, and a redirect unit making a proxy response of access of the client terminal to the target apparatus in response to the received access request information.

### BACKGROUND OF THE INVENTION

### FIELD OF THE INVENTION

The present invention relates to a virtual network building system, a virtual network building method, a small terminal, and an authentication server.

### BACKGROUND ART

In recent years, as a system for accessing a secure private network of an organization or the like from outside, a system which builds a virtual network such as a virtual private network (VPN) instead of a leased line has been frequently used. The VPN is implemented using a technique called tunneling in which communication data is encapsulated so as not to be viewed by general users on a public line for performing communication.

As a VPN system, there is a security architecture for Internet protocol-VPN (IPSec-VPN) or a secure socket layer-VPN (SSL-VPN) which is frequently used in the related art. The IPSec-VPN encrypts an IP packet using an IPSec protocol and performs access control in a network layer. On the other hand, the SSL-VPN encrypts an IP packet using an SSL and performs access control in an application layer.

However, in the IPSec-VPN system of the related art, a dedicated application is required to be installed on a client side, and thus a burden on an administrator is considerable. In addition, a secure private network is endangered, and thus there is a risk in terms of security.

On the other hand, in a case of the SSL-VPN, access is possible only by performing authentication using an ID and a password, and thus there is a problem in that a security strength is low, and an application availability is limited to a web.

JP-A-2007-202178 discloses a system in which access to a private network is securely provided from SSL/TSL by combining access control in the IPSec-VPN and the SSL-VPN. This is realized by including a routing element which performs a change to a routing table stored in a computer system; a receiver which receives an outbound packet from the computer system; a transmitter which communicates with the receiver and transmits information regarding the outbound packet to a VPN client application; and a packet rewriter which communicates with the receiver and the transmitter and rewrites address information of the outbound packet.

### SUMMARY OF THE INVENTION

However, in the system disclosed in JP-A-2007-202178, a URL of a server which performs authentication is open to the public, and thus there is a concern that unauthorized access may be performed or an attack such as server terror may be made by a malicious third person. In addition, since authentication is performed using an ID and a password, there is a problem in that anyone can easily access the server if the password is stolen from password cracking or wiretapping.

Therefore, the present invention has been made in light of the above-described circumstances, and an object thereof is to provide a virtual network building system, a virtual network building method, a virtual network building program, and a small terminal, capable of building a virtual network by automating access to a private network and authentication and without being required for an authentication server to have a web function and a VPN router function.

According to an aspect of the present invention, there is provided a virtual network building system including a client terminal that accesses a private network via a public line; an authentication server that performs authentication on the client terminal; a target apparatus that is disposed on the private network; and a small terminal that includes a connection unit connected to the client terminal, and an identifier transmission unit automatically transmitting an identifier to the authentication server via the client terminal in a state in which the connection unit is connected to the client terminal, and is attachable to and detachable from the client terminal, in which the authentication server includes an authentication unit that performs authentication on the basis of the identifier of the small terminal; a communication method selection unit that selects a communication protocol and an encryption method for communication between the client terminal and the authentication server when the authentication unit has performed the authentication; a distribution unit that distributes software for encrypting communication to the client terminal according to the selected communication protocol and encryption method; an encryption unit that encrypts communication with the client terminal on the basis of the selected communication protocol and encryption method; a reception unit that receives information (access request information) regarding a request for access to the target apparatus, which is automatically transmitted from the distributed software; and a redirect unit that makes a proxy response of access of the client terminal to the target apparatus in response to the received access request information.

The “private network” is a network in an organization such as a company. The private network may be a closed network which is isolated from a public line such as an intranet by a fire wall.

The “target apparatus” is an apparatus disposed on the private network. The target apparatus may be an apparatus which provides services in an organization such as a company, such as a mail server or a web server.

The “small terminal” is a small terminal used in the virtual network building system. The small terminal may be a terminal which can be connected to the client terminal and has a portable size.

The “connection unit” is a location connected to the client terminal. The connection may be performed using a serial bus such as universal serial bus (USB) or IEEE1394 as a connection interface.

The “identifier transmission unit” transmits an identifier to the authentication server. The identifier transmission unit may automatically transmit an identifier when the connection unit is connected to the client terminal.

The “identifier” refers to one in which information unique to the small terminal is written. Specifically, the identifier is an ID, authentication data, or the like of the small terminal.

In addition, the small terminal may not have a memory which records data transmitted from the client terminal. The small terminal may not have a memory function, for example, by directly writing the connection unit and the identifier transmission unit on a CMOS circuit and controlling the above-described elements.

The “authentication unit” authenticates a terminal which has access thereto. In a case where an identifier of the small terminal which is an access source and an identifier recorded on a database are compared with each other and match each other, access may be allowed.

The “distribution unit” distributes software to the client terminal which is an access source. Software for encrypting communication may be distributed. The distribution unit may select the kind of software to be distributed according to an identifier of the small terminal.

The “communication method selection unit” selects a communication method between the client terminal and the authentication server. The communication method selection unit may select a communication protocol and an encryption method on the basis of an identifier of the small terminal.

For example, authentication header (AH), encapsulated security payload (ESP), Internet key exchange (IKE), or the like may be selected as the communication protocol.

The “encryption unit” encrypts communication between a terminal which is an access source and the authentication server. The encryption unit may encrypt communication in any encryption method of RC4, 3DES, and AES, according to an identifier.

The “reception unit” receives information regarding a request for access to the target apparatus.

The “access request information” informs the authentication server of a request for which apparatus is desired to be accessed by the client terminal. The access request information may include information such as an IP address so as to specify the target apparatus which is desired to be accessed.

The “redirect unit” performs proxy connection between the client terminal and the target apparatus. The redirect unit may function as a proxy server. Specifically, when there are terminals which access the target apparatus from the public line, all of them are made to access the redirect unit, and only information which is not present in a cache thereof is acquired from the target apparatus (a request received from the public line is relayed to the target apparatus).

The “software” is distributed from the authentication server to the client terminal, and encrypts communication between the authentication server and the client terminal. The software which is distributed from the distribution unit to the client terminal may be preserved in the client terminal as a temporary file, or may be installed and be developed.

In addition, the software may cause the client terminal to have a network setting function of automatically changing network settings of the client terminal according to a selected communication protocol.

The “network setting function” is a function of rewriting the network settings. For example, the network setting function may change settings of an IP address, a network address, a routing table, and the like of the client terminal.

In addition, the software may cause the client terminal to have an erasure function of determining that connection between the connection unit and the client terminal is canceled and automatically erasing the access request information and the software.

The “erasure function” is a function of erasing information recorded on the small terminal. The erasure function may cause access request information or the software to be erased.

In addition, the software may cause the client terminal to have a screen display function of displaying an access screen on the client terminal.

The “access screen” is a screen displayed on the client terminal when the client terminal accesses the target apparatus. In addition, the software may have a function of determining that connection between the connection unit and the client terminal is canceled and not displaying the access screen. Specifically, the access screen may be displayed during connection between the small terminal and the client terminal, and may not be displayed when the connection is canceled.

The “screen display function” is a function of displaying the access screen on the client terminal. In addition, the screen display function may cause identification information indicating a position of the authentication server to be kept secret. For example, an URL of the authentication server or the target apparatus may be made not to be displayed on the access screen.

The “client terminal” is a terminal having a circuit communicating with the authentication server. For example, there is a portable terminal such as a laptop or a mobile phone.

In addition, according to another aspect of the present invention, there is provided a method of building a virtual network including a client terminal that accesses a private network via a public line, an authentication server that performs authentication on the client terminal, and a target apparatus that is disposed on the private network, the method including causing a small terminal which is attachable to and detachable from the client terminal to be connected to the client terminal, and to automatically transmit an identifier to the authentication server via the client terminal in a state in which a connection unit is connected to the client terminal; and causing the authentication server to perform authentication on the basis of the identifier of the small terminal, to select a communication protocol and an encryption method for communication between the client terminal and the authentication server when the authentication unit has performed the authentication, to distribute software for encrypting communication to the client terminal according to the selected communication protocol and encryption method, to encrypt communication with the client terminal on the basis of the selected communication protocol and encryption method, to receive information (access request information) regarding a request for access to the target apparatus, which is automatically transmitted from the distributed software, and to make a proxy response of access of the client terminal to the target apparatus in response to the received access request information.

Further, according to still another aspect of the present invention, there is provided a small terminal of a virtual network building system including a client terminal that accesses a private network via a public line, an authentication server that performs authentication on the client terminal, and a target apparatus that is disposed on the private network, the small terminal including a connection unit that is connected to the client terminal; an identifier storage unit that records an identifier for causing the authentication server to perform authentication; and an identifier transmission unit that automatically transmits an identifier to the authentication server via the client terminal in a state in which the connection unit is connected to the client terminal, in which the small terminal causes the authentication server to authenticate the client terminal on the basis of the identifier so that the client terminal accesses the target apparatus, and is attachable to and detachable from the client terminal.

Furthermore, according to still another aspect of the present invention, there is provided an authentication server of a virtual network building system including a client terminal that accesses a private network via a public line, the authentication server that performs authentication on the client terminal, and a target apparatus that is disposed on the private network, the authentication server including a reception unit that receives an identifier recorded on a small terminal connected to the client terminal; an authentication unit that performs authentication on the basis of the identifier; a communication method selection unit that selects a communication protocol and an encryption method for communication between the client terminal and the authentication server when the authentication unit has performed the authentication; a distribution unit that distributes software for encrypting communication to the client terminal according to the selected communication protocol and encryption method; an encryption unit that encrypts communication with the client terminal on the basis of the selected communication protocol and encryption method; a reception unit that receives information (access request information) regarding a request for access to the target apparatus, which is automatically transmitted from the distributed software; and a redirect unit that makes a proxy response of access of the client terminal to the target apparatus in response to the received access request information.

The virtual network building method in a virtual network building system related to the present invention includes causing a small terminal which is attachable to and detachable from a client terminal to be connected to the client terminal and to automatically transmit an identifier to an authentication server via the client terminal in a state in which a connection unit is connected to the client terminal; and causing the authentication server to perform authentication on the basis of the identifier of the small terminal, to select a communication protocol and an encryption method for communication between the client terminal and the authentication server when the authentication unit has performed the authentication, to distribute software for encrypting communication to the client terminal according to the selected communication protocol and encryption method, to encrypt communication with the client terminal on the basis of the selected communication protocol and encryption method, to receive information (access request information) regarding a request for access to a target apparatus, which is automatically transmitted from the distributed software, and to make a proxy response of access of the client terminal to the target apparatus in response to the received access request information. Therefore, the small terminal can automatically perform connection to the authentication server, and thus it is possible to restrict terminals which can access a private network in an organization such as a company. In addition, it is not necessary to mount a web function and a VPN router function in the authentication server, and thus it is possible to reduce a probability of being attacked by a malicious third person.

In addition, the small terminal related to the present invention includes a connection unit which is connected to the client terminal; an identifier storage unit which records an identifier for causing the authentication server to perform authentication; and an identifier transmission unit which automatically transmits an identifier to the authentication server via the client terminal in a state in which the connection unit is connected to the client terminal. In this case, since the small terminal causes the authentication server to authenticate the client terminal on the basis of the identifier so that the client terminal accesses the target apparatus, and is attachable to and detachable from the client terminal, a user connects the small terminal to the client terminal and thus can automatically access the target apparatus on a private network.

In addition, the authentication server related to the present invention includes a reception unit which receives an identifier recorded on the small terminal connected to the client terminal; an authentication unit which performs authentication on the basis of the identifier; a communication method selection unit which selects a communication protocol and an encryption method for communication between the client terminal and the authentication server when the authentication unit has performed the authentication; a distribution unit which distributes software for encrypting communication to the client terminal according to the selected communication protocol and encryption method; an encryption unit which encrypts communication with the client terminal on the basis of the selected communication protocol and encryption method;

a reception unit which receives information (access request information) regarding a request for access to the target apparatus, which is automatically transmitted from the distributed software; and a redirect unit which makes a proxy response of access of the client terminal to the target apparatus in response to the received access request information. Therefore, it is not necessary to mount a web function in the authentication server, and thus it is possible to reduce a probability of being attacked by a malicious third person.

In addition, the encryption unit related to the present invention encrypts communication in any encryption method of RC4, 3DES, and AES, according to an identifier, and thus it is possible to select an appropriate encryption method according to a security level of a network in an organization.

In addition, since the small terminal related to the present invention does not have a memory storing data transmitted from the client terminal, it is possible to prevent information on the small terminal from being copied and to prevent information from being stolen by storing in the small terminal.

Further, since the software related to the present invention has the network setting function of automatically changing network settings of the client terminal according to a selected communication protocol, a dedicated network apparatus such as a router is not necessary when a user accesses a network in a company, and a complex network setting process can be omitted.

In addition, since the software related to the present invention has the erasure function of determining that connection between the connection unit and the client terminal is canceled, and erasing access request information and the software, information regarding connection can be erased from the client terminal, and thus history can be prevented from being used for the wrong purpose.

Further, since the software related to the present invention has the screen display function of displaying an access screen on the client terminal, it is possible to prevent access to the authentication server from a browser mounted in the client terminal, and thus information such as a cache or access history can be managed by software.

In addition, since the screen display function related to the present invention causes identification information indicating a position of the authentication server to be kept secret, the position of the authentication server is kept secret from a malicious third person, and thus it is possible to improve security.

Further, since the software related to the present invention has a function of determining that connection between the connection unit and the client terminal is canceled and not displaying an access screen, the small terminal is disconnected from the client terminal, and thus the access screen can be made not to be displayed.

### BRIEF DESCRIPTION OF THE DRAWINGS

FIG. 1 is a schematic diagram illustrating a process in a virtual network building system according to a first embodiment of the present invention.

FIG. 2 is a block diagram of the virtual network building system according to the first embodiment of the present invention.

FIG. 3 is a flowchart illustrating a process in a small terminal according to the first embodiment of the present invention.

FIG. 4 is a flowchart illustrating a process in an authentication server according to the first embodiment of the present invention.

FIG. 5 is a flowchart illustrating a process during access of a client terminal according to the first embodiment of the present invention.

FIG. 6 is a flowchart illustrating a process during disconnection of the client terminal according to the first embodiment of the present invention.

FIG. 7 is a block diagram of a virtual network building system according to a second embodiment of the present invention.

FIG. 8 is a flowchart illustrating a process during access of a client terminal according to the second embodiment of the present invention.

FIG. 9 is a flowchart illustrating a process during disconnection of the client terminal according to the second embodiment of the present invention.

### DETAILED DESCRIPTION OF THE INVENTION

### First Embodiment

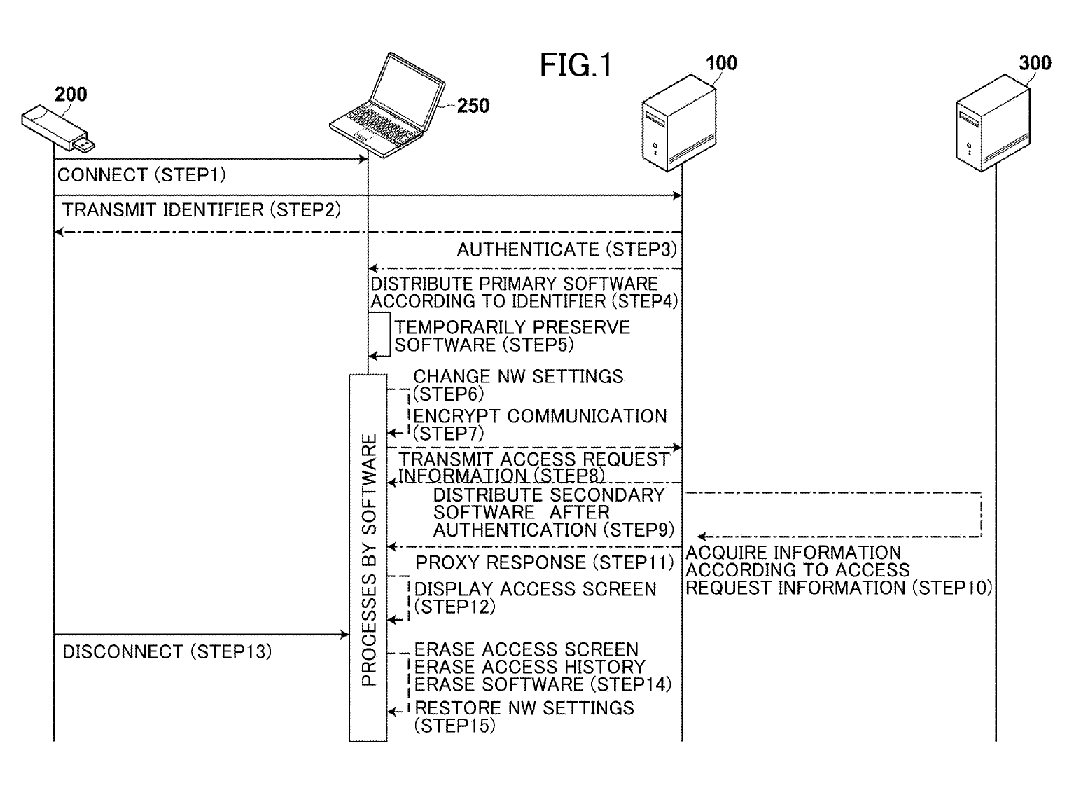

Hereinafter, the first embodiment of the present invention will be described with reference to FIGS. 1 to 6.

In the present embodiment, a virtual network building system includes an authentication server 100, a client terminal 250, a small terminal 200, and a target apparatus 300.

In the virtual network building system according to the first embodiment, the small terminal 200 includes a connection unit 202 which is connected to the client terminal 250, and an identifier transmission unit 203 which automatically transmits an identifier to the authentication server 100 via the client terminal 250 in a state in which the connection unit 202 is connected thereto, and is attachable to and detachable from the client terminal 250. In addition, the authentication server 100 includes an authentication unit 102 which performs authentication on the basis of the identifier of the small terminal 200; a communication method selection unit 112 which selects a communication protocol and an encryption method for communication between the client terminal 250 and the authentication server 100 when the authentication unit 102 has performed the authentication; a distribution unit 111 which distributes software for encrypting communication to the client terminal 250 according to the selected communication protocol and encryption method; an encryption unit 113 which encrypts communication with the client terminal 250 on the basis of the selected communication protocol and encryption method; a reception unit 114 which receives information (access request information) regarding a request for access to the target apparatus 300, which is automatically transmitted from the distributed software; and a redirect unit 115 which makes a proxy response of access of the client terminal 250 to the target apparatus 300 in response to the received access request information.

The virtual network building system includes a computer or a server, and is operated as various function units by a CPU executing a program recorded on a ROM on the basis of various inputs. The program may be stored in a storage medium such as a CD-ROM or may be distributed via a network such as Internet so as to be installed in the computer.

A description will be made of an outline of a process in the virtual network building system according to the present embodiment with reference to FIG. 1.

First, when the small terminal 200 is connected to the client terminal 250 (STEP1), the small terminal 200 transmits an identifier thereof to the authentication server 100 (STEP2).

The identifier refers to one in which information unique to the small terminal 200 is written. Specifically, the identifier is an ID, authentication data, or the like of the small terminal 200.

The authentication server 100 performs authentication according to the transmitted identifier (STEP3). The authentication server 100 uses the identifier which is automatically transmitted from the small terminal 200 in the authentication, and thus is not required to have a web function for access and can further increase a security strength.

If the authentication succeeds, the authentication server 100 distributes software to the client terminal 250 according to the identifier (STEP4).

The software is distributed from the authentication server 100 to the client terminal 250, and encrypts communication between the authentication server 100 and the client terminal 250. The software which is distributed from the distribution unit 111 to the client terminal 250 is preserved in the client terminal 250 as a temporary file in the present embodiment, but may be installed and be developed.

The software has an encryption function and the like. The authentication server 100 selects an encryption method corresponding to the identifier among a plurality of encryption methods, and distributes appropriate software. In the present embodiment, the client terminal 250 and the authentication server 100 perform encryption using 3DES, and perform communication in the IPSec-VPN method. In the present embodiment, the software is distributed so as to be divided into primary software and secondary software. Both of the two encrypt communication from the client terminal 250 to the authentication server 100. The primary software is distributed after the authentication server 100 authenticates an identifier transmitted by the small terminal 200, and transmits access request information. The secondary software is distributed after the authentication server 100 performs the authentication and displays an access screen on the basis of the access request information transmitted by the primary software.

The client terminal 250 preserves the distributed primary software as a temporary file (STEP5).

The primary software appropriately changes network settings when the network settings of the client terminal 250 are required to be changed (STEP6). In the present embodiment, the client terminal 250 accesses the authentication server 100 by the use of the IPSec-VPN, and thus the settings are required to be changed. In this case, settings of an IP address, a network address, a default gateway, and the like of the client terminal 250 are rewritten so as to belong to the same network as an intranet on which the target apparatus 300 is disposed, and a location of a router of the intranet is added to a routing table. As above, since the software automatically changes the network settings of the client terminal 250, a complex network setting process or equipment such as a dedicated router is not necessary.

When the network settings of the client terminal 250 are in an appropriate state, the primary software encrypts communication with the authentication server 100 (STEP7). In the present embodiment, the encryption is performed using 3DES. The primary software transmits access request information to the authentication server 100 in the encrypted communication (STEP8).

The access request information informs the authentication server 100 of a request for which apparatus is desired to be accessed. Specifically, the access request information includes information such as an IP address so as to specify the target apparatus 300 which is desired to be accessed. In the present embodiment, Ip addresses of a mail server 302 and a business server 303 are included.

The authentication server 100 authenticates whether or not the primary software is valid on the basis of an ID, distribution history, and the like of the primary software (STEP9), and distributes secondary software to the client terminal 250 in which the authentication thereof has succeeded (STEP9). In addition, the redirect unit 115 makes a proxy response (STEP11). Specifically, in relation to information which is present on a cache of the authentication server 100 of the access request information, the information on the cache is returned in reply, and information which is absent on the cache is acquired from the mail server 302 or the business server 303 so as to be relayed to the client terminal 250 (STEP10).

The secondary software displays an access screen on the client terminal 250, and displays the information acquired from the authentication server 100 (STEP12). Accordingly, a user can acquire a mail on the mail server 302 in a company from a public line 800, and can inspect a file or the like stored on the business server 303.

The access screen is a screen which is displayed on the client terminal 250 when the client terminal 250 accesses the target apparatus 300 via the relay of the authentication server 100. In the present embodiment, the user inspects a mail on the mail server 302 or a file on the business server 303 from the access screen. Specifically, on a screen such as a browser having a tab structure, a display target is changed by a tab so as to inspect a mail or a file.

The secondary software may determine disconnection between the connection unit 202 and the client terminal 250 and may instruct the access screen not to be displayed.

The access screen is a screen which is displayed on the client terminal 250 when the client terminal 250 accesses the target apparatus 300 via the relay of the authentication server 100.

The software may determine disconnection between the connection unit 202 and the client terminal 250 and may instruct the access screen not to be displayed.

In the present embodiment, the access screen is displayed while the small terminal 200 is connected to the client terminal 250, and is not displayed when the connection is canceled.

When the connection between the small terminal 200 and the client terminal 250 is canceled (STEP13), the secondary software erases the access screen, the access history, and the software (STEP14). In addition, the network settings are restored to circumstances before the communication is performed (STEP15).

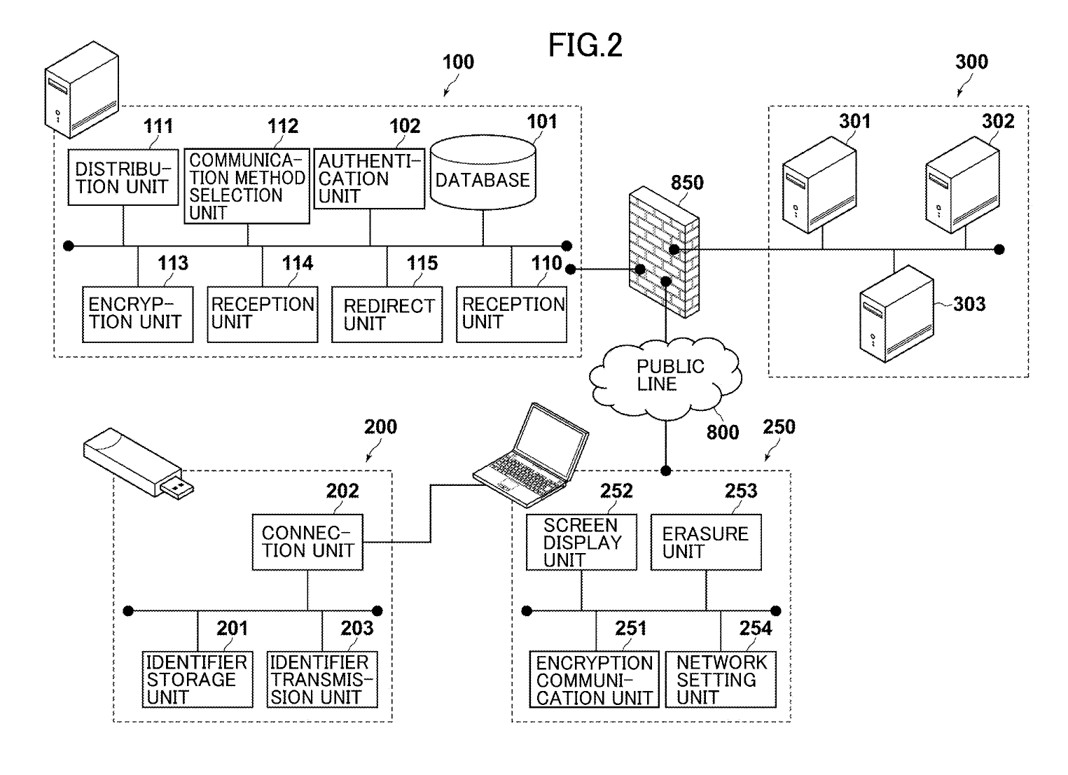

FIG. 2 is a block diagram of the virtual network building system according to the present embodiment. In the present embodiment, the client terminal 250 accesses the target apparatus 300 on a private network via the public line 800.

The private network is a network in an organization such as a company. In the present embodiment, the private network indicates a company's intranet which is isolated from the public line 800 by a fire wall 850.

The target apparatus 300 is an apparatus disposed on the private network. In the present embodiment, the target apparatus 300 is the mail server 302, a web server 301, or the business server 303. The target apparatus 300 is disposed inside the fire wall 850.

The client terminal 250 can access the target apparatus 300 from the public line 800 when the small terminal 200 is inserted thereinto. In this case, it is necessary to pass authentication by the authentication server 100. The authentication server 100 is installed on a DMZ. On the other hand, the client terminal 250 and the small terminal 200 are installed on the public line 800.

The small terminal 200 is a small terminal used in the virtual network building system. The small terminal 200 is connectable to the client terminal 250 and has a portable size. The small terminal 200 includes an identifier storage unit 201, the connection unit 202, and the identifier transmission unit 203.

The identifier storage unit 201 is a region on a circuit, in which an identifier is written.

The small terminal 200 is connected to the client terminal 250 in the connection unit 202. The connection may be performed using a serial bus such as universal serial bus (USB) or IEEE1394 as a connection interface. In the present embodiment, the small terminal 200 performs USB connection to the client terminal 250.

The identifier transmission unit 203 transmits an identifier to the authentication server 100. The identifier transmission unit 203 automatically transmits an identifier when the connection unit 202 is connected to the client terminal 250.

In addition, the small terminal 200 may not have a memory function. The small terminal 200 may not have a memory function, for example, by directly writing the identifier storage unit 201, the connection unit 202, and the identifier transmission unit 203 on a CMOS circuit and controlling the above-described elements. In this case, it is possible to prevent an identifier of the small terminal 200 from being stolen by a malicious user or information on the client terminal 250 from being copied to the small terminal 200.

In addition, as illustrated in FIG. 2, the authentication server 100 includes a database 101, the authentication unit 102, a reception unit 110, the distribution unit 111, the communication method selection unit 112, the encryption unit 113, the reception unit 114, and the redirect unit 115.

The database 101 preserves information regarding an identifier of the small terminal 200. When the small terminal 200 transmits the identifier, the authentication server 100 performs authentication in comparison with the information preserved in the database 101.

The reception unit 110 receives the identifier transmitted from the small terminal 200.

The authentication unit 102 authenticates a terminal which has access thereto. In the present embodiment, in a case where the identifier of the small terminal 200 which is an access source and the identifier recorded on the database 101 are compared with each other and match each other, access is allowed.

The distribution unit 111 distributes software to a terminal which is an access source. Software (primary and secondary) for encrypting communication may be distributed. In the present embodiment, the distribution unit 111 selects the kind of software to be distributed according to an identifier of the small terminal 200.

The communication method selection unit 112 selects a communication method between a terminal which is an access source and the authentication server 100. The communication method selection unit 112 selects a communication protocol and an encryption method on the basis of the identifier of the small terminal 200. For example, authentication header (AH), encapsulated security payload (ESP), Internet key exchange (IKE), or the like may be selected as the communication protocol.

The encryption unit 113 encrypts communication between a terminal which is an access source and the authentication server 100. The encryption unit 113 may encrypt communication in any encryption method of RC4, 3DES, and AES, according to an identifier.

The reception unit 114 receives information regarding a request for access to the target apparatus 300.

The redirect unit 115 performs proxy connection between the client terminal 250 and the target apparatus 300. The redirect unit 115 may function as a proxy server. Specifically, when there are terminals which access the target apparatus 300 from the public line 800, all of them are made to access the redirect unit 115, and only information which is not present in a cache thereof is acquired from the target apparatus 300 (a request received from the public line 800 is relayed to the target apparatus 300).

An encryption communication unit 251 is provided to the client terminal 250 when primary software and secondary software are distributed thereto as illustrated in FIG. 2. In addition, the primary software and secondary software may have a screen display function, an erasure function, and a network setting function as in the present embodiment. For this reason, in the present embodiment, the primary software and secondary software provide a screen display unit 252, an erasure unit 253, and a network setting unit 254 to the client terminal 250 when the primary software and the secondary software are distributed thereto as in FIG. 2.

The encryption communication unit 251 encrypts communication from the client terminal 250 to the authentication server 100. In the present embodiment, the encryption is performed in a 3DES method, and communication is performed using the IPSec-VPN.

The screen display unit 252 displays an access screen on the client terminal 250. In addition, the screen display unit 252 may keep identification information indicating a position of the authentication server 100 secret. For example, an URL of the authentication server 100 or the target apparatus 300 may be made not to be displayed on the access screen. Accordingly, it is possible to keep the URL of the authentication server 100 secret from a user and to thus prevent an attack from a malicious third person on the basis of the URL of the authentication server 100.

The network setting unit 254 rewrites network settings of the client terminal 250. In the present embodiment, the IPSec-VPN is selected as a communication method, and thus settings of an IP address, a network address, a routing table, and the like of the client terminal 250 are required to be changed.

The erasure unit 253 erases information recorded on the small terminal 200. In the present embodiment, access request information, access history, a cache, and a cookie are erased from the client terminal 250.

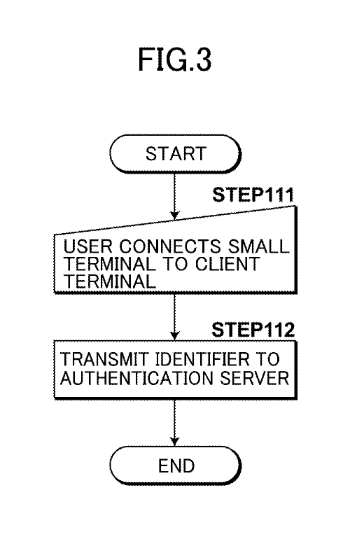

With reference to FIG. 3, a process flow of the small terminal 200 will be described in detail. FIG. 3 is a flowchart illustrating a process in the small terminal 200.

First, a user who wants to access the target apparatus 300 and wants to be provided with a service connects the small terminal 200 to the client terminal 250 (STEP111). At this time, the user selects the small terminal 200 to be inserted, according to a security level of the target apparatus 300. In the present embodiment, a case of connection using the IPSec-VPN will be described as an example.

If connection to a company's intranet is to be performed using the IPSec-VPN, the small terminal 200 corresponding to the IPSec-VPN is used. When the small terminal 200 recognizes connection to the client terminal 250, the small terminal 200 automatically executes an internal program so as to automatically transmits an identifier to the authentication server 100 (STEP112).

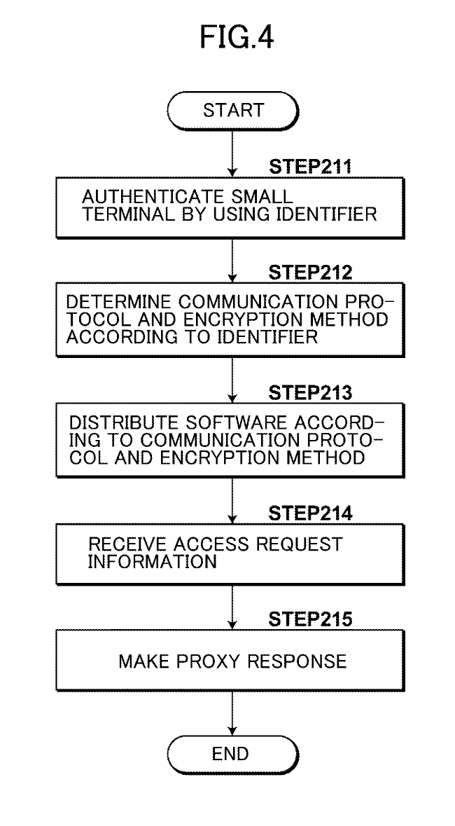

Next, a process flow of the authentication server 100 will be described with reference to FIG. 4. When an identifier is transmitted from the small terminal 200 via the client terminal 250, the authentication server 100 authenticates the small terminal 200 on the basis of the identifier (STEP211). If the authentication succeeds, the authentication server 100 determines a communication protocol and an encryption method according to the identifier (STEP212). The authentication server 100 distributes software necessary to realize the determined communication protocol and encryption method to the client terminal 250 (STEP213). When access request information is received from the client terminal 250 in encrypted communication (STEP214), the authentication server 100 makes a proxy response (STEP215).

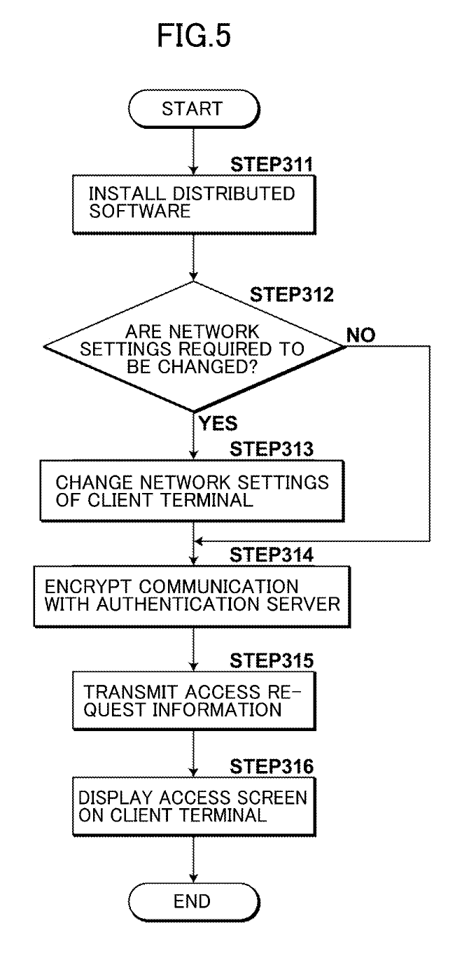

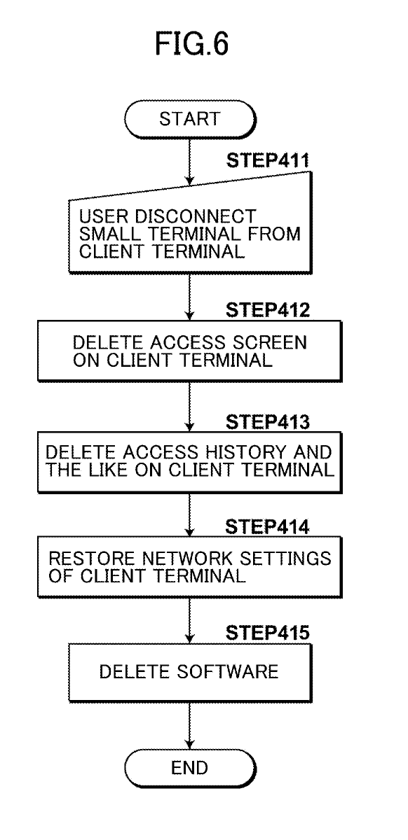

Next, a process flow of the client terminal 250 which preserves software will be described with reference to FIGS. 5 and 6.

FIG. 5 is a chart illustrating a process flow when the client terminal 250 which preserves software accesses the target apparatus 300. When software distributed to the client terminal 250 is preserved (STEP311), the network setting unit 254 determines whether or not network settings of the client terminal 250 are required to be changed (STEP312). In the present embodiment, since a network address, a routing table, and the like of the client terminal 250 are required to be changed (STEP312; YES), the settings are changed (STEP313). When the network settings of the client terminal 250 are communicatable with the authentication server 100, communication is encrypted (STEP314), and access request information is transmitted to the authentication server 100 (STEP315). When the requested information is encrypted and is returned from the authentication server 100, an access screen is displayed on the client terminal 250 so as to display the received information (STEP316).

FIG. 6 is a chart illustrating a process flow when connection between the client terminal 250 and the small terminal 200 is canceled. When a user removes the small terminal 200 from the client terminal 250 (STEP411), the software detects that the connection is canceled. At this time, the screen display unit 252 erases the access screen which is displayed on the client terminal 250 (STEP412). Accordingly, it is possible to terminate communication with the authentication server 100 without the user having to explicitly close the access screen. The erasure unit 253 deletes history such as access history, cache information, and a cookie on the client terminal 250 (STEP413). Therefore, it is possible to prevent unauthorized access to the target apparatus 300 by using the history after the user removes the small terminal 200. In a case where the network setting unit 254 has changed the network settings of the client terminal 250, the settings are restored (STEP414), and the software preserved on the client terminal 250 is automatically deleted (STEP415).

### Second Embodiment

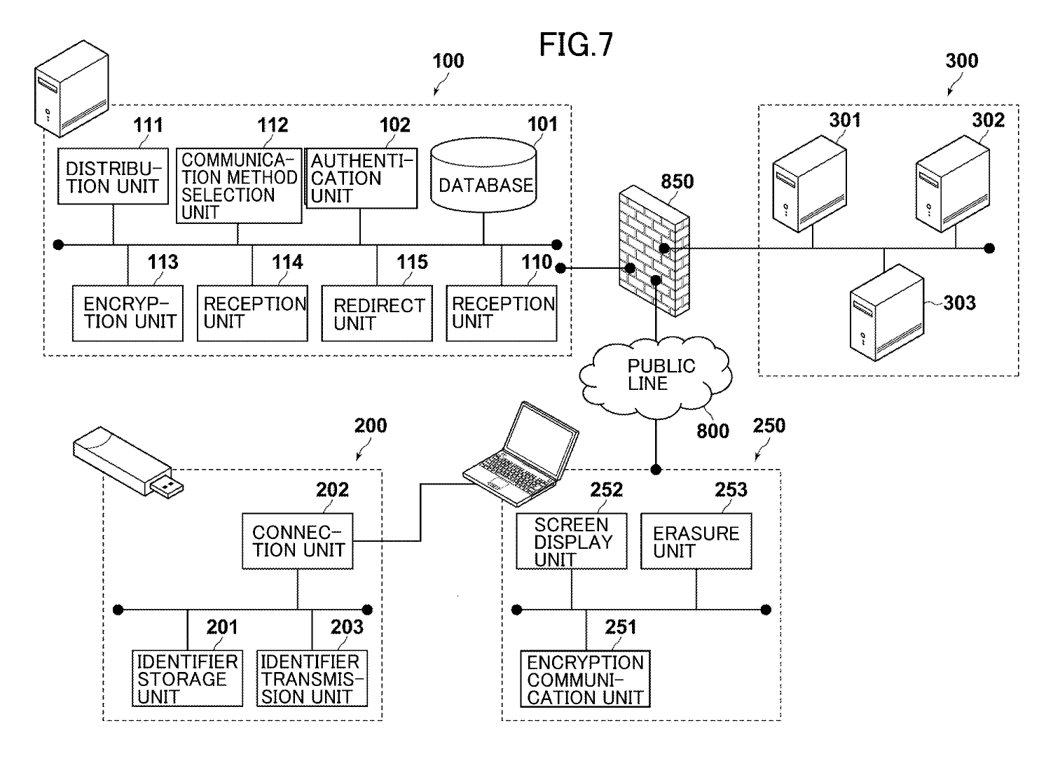

Hereinafter, the second embodiment of the present invention will be described with reference to FIGS. 7 to 9.

In the present embodiment, a virtual network building system includes an authentication server 100, a client terminal 250, a small terminal 200, and a target apparatus 300.

In the virtual network building system according to the second embodiment, the small terminal 200 includes a connection unit 202 which is connected to the client terminal 250, and an identifier transmission unit 203 which automatically transmits an identifier to the authentication server 100 via the client terminal 250 in a state in which the connection unit 202 is connected thereto, and is attachable to and detachable from the client terminal 250. In addition, the authentication server 100 includes an authentication unit 102 which performs authentication on the basis of the identifier of the small terminal 200; a communication method selection unit 112 which selects a communication protocol and an encryption method for communication between the client terminal 250 and the authentication server 100 when the authentication unit 102 has performed the authentication; a distribution unit 111 which distributes software for encrypting communication to the client terminal 250 according to the selected communication protocol and encryption method; an encryption unit 113 which encrypts communication with the client terminal 250 on the basis of the selected communication protocol and encryption method; a reception unit 114 which receives information (access request information) regarding a request for access to the target apparatus 300, which is automatically transmitted from the distributed software; and a redirect unit 115 which makes a proxy response of access of the client terminal 250 to the target apparatus 300 in response to the received access request information.

In the present embodiment, a user accesses a private network in the SSL-VPN method. Therefore, network settings of the client terminal 250 are not required to be changed.

FIG. 7 is a block diagram of the virtual network building system according to the present embodiment. In the present embodiment, the client terminal 250 accesses the target apparatus 300 on a private network via the public line 800.

In the present embodiment, the small terminal 200 includes an identifier storage unit 201, the connection unit 202, and the identifier transmission unit 203.

In addition, the authentication server 100 includes a database 101, the authentication unit 102, a reception unit 110, the distribution unit 111, the communication method selection unit 112, the encryption unit 113, the reception unit 114, and the redirect unit 115.

An encryption communication unit 251 is provided to the client terminal 250 when software is distributed thereto as illustrated in FIG. 7. In the present embodiment, communication is encrypted using the SSL. In addition, the software has a screen display function and an erasure function as in the present embodiment. For this reason, in the present embodiment, the software provides a screen display unit 252 and an erasure unit 253 to the client terminal 250 when the software is distributed thereto as in FIG. 7.

The encryption communication unit 251 encrypts communication from the client terminal 250 to the authentication server 100. In the present embodiment, HTTPS communication using the SSL method is performed.

The screen display unit 252 displays an access screen on the client terminal 250. In addition, the screen display unit 252 may keep identification information indicating a position of the authentication server 100 secret. For example, an URL of the authentication server 100 or the target apparatus 300 may not be displayed on the access screen. Accordingly, it is possible to keep the URL of the authentication server 100 secret from a user and to thus prevent an attack from a malicious third person on the basis of the URL of the authentication server 100.

The network setting unit 254 rewrites network settings of the client terminal 250. In the present embodiment, since communication is performed using the SSL-VPN, the network settings of the client terminal 250 is not required to be changed. However, in a case where a communication method such as the IPSec-VPN is selected, the settings of an IP address, a network address, a routing table, and the like of the client terminal 250 are required to be changed.

The erasure unit 253 erases information recorded on the small terminal 200. In the present embodiment, access request information, access history, a cache, and a cookie are erased from the client terminal 250.

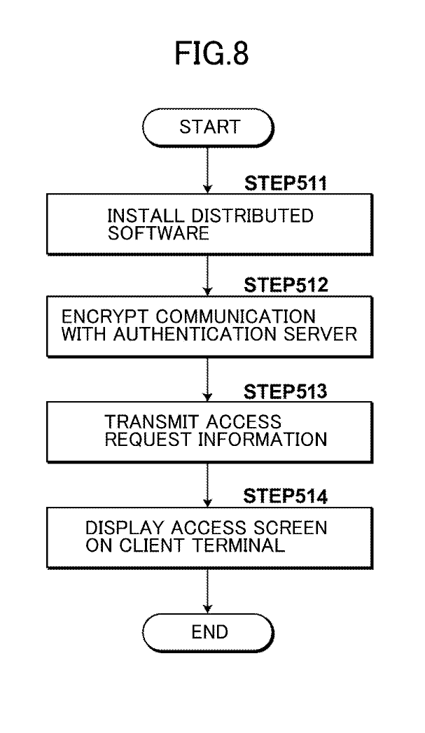

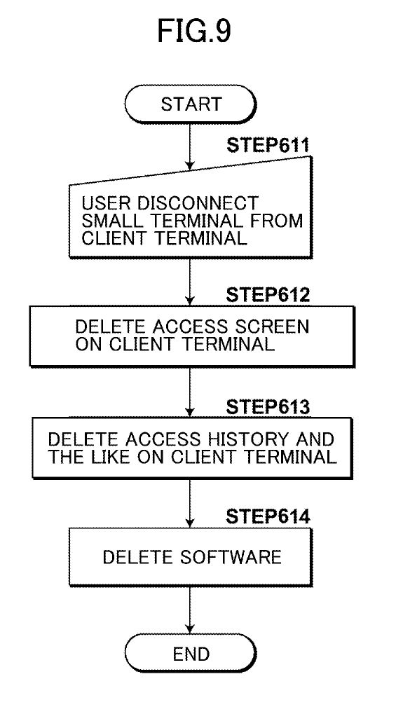

Next, a process flow of the client terminal 250 which preserves software will be described with reference to FIGS. 8 and 9.

FIG. 8 is a chart illustrating a process flow when the client terminal 250 which preserves software accesses the target apparatus 300. When software distributed to the client terminal 250 is preserved (STEP511), communication is encrypted (STEP512), and access request information is transmitted to the authentication server 100 (STEP513). When the requested information is encrypted and is returned from the authentication server 100, an access screen is displayed on the client terminal 250 so as to display the received information (STEP514).

FIG. 9 is a chart illustrating a process flow when connection between the client terminal 250 and the small terminal 200 is canceled. When a user removes the small terminal 200 from the client terminal 250 (STEP611), the software detects that the connection is canceled. At this time, the screen display unit 252 erases the access screen which is displayed on the client terminal 250 (STEP612). Accordingly, it is possible to terminate communication with the authentication server 100 without the user having to explicitly close the access screen. The erasure unit 253 deletes history such as access history, cache information, and a cookie on the client terminal 250 (STEP613). Therefore, it is possible to prevent unauthorized access to the target apparatus 300 by using the history after the user removes the small terminal 200. Successively, the software preserved on the client terminal 250 is automatically deleted (STEP614).

The other configurations and functions are the same as in the first embodiment.

A virtual network building method in a virtual network building system includes causing a small terminal 200 which is attachable to and detachable from a client terminal 250 to be connected to the client terminal 250 and to automatically transmit an identifier to an authentication server 100 via the client terminal 250 in a state in which a connection unit 202 is connected thereto; and causing the authentication server 100 to perform authentication on the basis of the identifier of the small terminal 200, to select a communication protocol and an encryption method for communication between the client terminal 250 and the authentication server 100 when the authentication unit 102 has performed the authentication, to distribute software for encrypting communication to the client terminal 250 according to the selected communication protocol and encryption method, to encrypt communication with the client terminal 250 on the basis of the selected communication protocol and encryption method, to receive information (access request information) regarding a request for access to a target apparatus 300, which is automatically transmitted from the distributed software, and to make a proxy response of access of the client terminal 250 to the target apparatus 300 in response to the received access request information. Therefore, the small terminal 200 can automatically perform connection to the authentication server 100, and thus it is possible to restrict terminals which can access a private network in an organization such as a company. In addition, it is not necessary to mount a web function and a VPN router function in the authentication server 100, and thus it is possible to reduce a probability of being attacked by a malicious third person.

In addition, the small terminal 200 includes a connection unit 202 which is connected to the client terminal 250; an identifier storage unit 201 which records an identifier for causing the authentication server 100 to perform authentication; and an identifier transmission unit 203 which automatically transmits an identifier to the authentication server 100 via the client terminal 250 in a state in which the connection unit 202 is connected to the client terminal 250. In this case, since the small terminal 200 causes the authentication server 100 to authenticate the client terminal 250 on the basis of the identifier so that the client terminal 250 accesses the target apparatus 300, and is attachable to and detachable from the client terminal 250, a user connects the small terminal 200 to the client terminal 250 and thus can automatically access the target apparatus 300 on a private network.

In addition, the authentication server 100 includes a reception unit 110 which receives an identifier recorded on the small terminal 200 connected to the client terminal 250; an authentication unit 102 which performs authentication on the basis of the identifier; a communication method selection unit 112 which selects a communication protocol and an encryption method for communication between the client terminal 250 and the authentication server 100 when the authentication unit 102 has performed the authentication; a distribution unit 111 which distributes software for encrypting communication to the client terminal 250 according to the selected communication protocol and encryption method; an encryption unit 113 which encrypts communication with the client terminal on the basis of the selected communication protocol and encryption method; a reception unit 114 which receives information (access request information) regarding a request for access to the target apparatus 300, which is automatically transmitted from the distributed software; and a redirect unit 115 which makes a proxy response of access of the client terminal 250 to the target apparatus 300 in response to the received access request information. Therefore, it is not necessary to mount a web function in the authentication server 100, and thus it is possible to reduce a probability of being attacked by a malicious third person.

In addition, the encryption unit 113 encrypts communication in any encryption method of RC4, 3DES, and AES, according to an identifier, and thus it is possible to select an appropriate encryption method according to a security level of a network in an organization.

In addition, since the small terminal 200 does not have a memory storing data transmitted from the client terminal 250, it is possible to prevent information on the small terminal 200 from being copied and to prevent information from being stored in the small terminal 200 so as to be stolen.

Further, since the software has a network setting function of automatically changing network settings of the client terminal 250 according to the selected communication protocol, a dedicated network apparatus such as a router is not necessary when a user accesses a network in a company, and a complex network setting process can be omitted.

In addition, since the software has an erasure function of determining that connection between the connection unit 202 and the client terminal 250 is canceled, and erasing access request information and the software, information regarding connection can be erased from the client terminal 250, and thus history can be prevented from being used for the wrong purpose.

Further, since the software has a screen display function of displaying an access screen on the client terminal 250, it is possible to prevent access to the authentication server 100 from a browser mounted in the client terminal 250, and thus information such as a cache or access history can be managed by software.

In addition, since the screen display function causes identification information indicating a position of the authentication server 100 to be kept secret, the position of the authentication server 100 is kept secret from a malicious third person, and thus it is possible to improve security.

Further, since the software has a function of determining that connection between the connection unit 202 and the client terminal 250 is canceled and not displaying an access screen, the small terminal 200 is disconnected from the client terminal 250, and thus the access screen can be made not to be displayed.

1. A virtual network building system comprising:
a client terminal that accesses a private network via a public line;
an authentication server that performs authentication on the client terminal;
a target apparatus that is disposed on the private network; and
a small terminal that includes a connection unit connected to the client terminal, and an identifier transmission unit automatically transmitting an identifier to the authentication server via the client terminal in a state in which the connection unit is connected to the client terminal, and is attachable to and detachable from the client terminal,
wherein the authentication server includes
an authentication unit that performs authentication on the basis of the identifier of the small terminal;
a communication method selection unit that selects a communication protocol and an encryption method for communication between the client terminal and the authentication server when the authentication unit has performed the authentication;
a distribution unit that distributes software for encrypting communication to the client terminal according to the selected communication protocol and encryption method;
an encryption unit that encrypts communication with the client terminal on the basis of the selected communication protocol and encryption method;
a reception unit that receives information regarding a request for access to the target apparatus, which is automatically transmitted from the distributed software; and
a redirect unit that makes a proxy response of access of the client terminal to the target apparatus in response to the received access request information.

2. The virtual network building system according to claim 1,
wherein the encryption unit encrypts communication in any encryption method of RC4, 3DES, and AES, according to the identifier.

3. The virtual network building system according to claim 1,
wherein the small terminal does not have a memory which records data transmitted from the client terminal.

4. The virtual network building system according claim 1,
wherein the software causes the client terminal to have a network setting function of automatically changing network settings of the client terminal according to the selected communication protocol.

5. The virtual network building system according to claim 1,
wherein the software provides the client terminal with an erasure unit which determines that connection between the connection unit and the client terminal is canceled, and upon determination, automatically erases the access request information and the software.

6. The virtual network building system according to claim 1,
wherein the software has a screen display function of displaying an access screen on the client terminal.

7. The virtual network building system according to claim 6,
wherein the screen display function causes identification information indicating a position of the authentication server to be kept secret.

8. The virtual network building system according to claim 6,
wherein the software has a function of determining that connection between the connection unit and the client terminal is canceled and not displaying the access screen.

9. A method of building a virtual network including a client terminal that accesses a private network via a public line, an authentication server that performs authentication on the client terminal, and a target apparatus that is disposed on the private network, the method comprising:
causing a small terminal which is attachable to and detachable from the client terminal to be connected to the client terminal, and to automatically transmit an identifier to the authentication server via the client terminal in a state in which a connection unit is connected to the client terminal; and
causing the authentication server to perform authentication on the basis of the identifier of the small terminal, to select a communication protocol and an encryption method for communication between the client terminal and the authentication server when an authentication unit has performed the authentication, to distribute software for encrypting communication to the client terminal according to the selected communication protocol and encryption method, to encrypt communication with the client terminal on the basis of the selected communication protocol and encryption method, to receive information regarding a request for access to the target apparatus, which is automatically transmitted from the distributed software, and to make a proxy response of access of the client terminal to the target apparatus in response to the received access request information.

10. A small terminal of a virtual network building system including a client terminal that accesses a private network via a public line, an authentication server that performs authentication on the client terminal, and a target apparatus that is disposed on the private network, the small terminal comprising:
a connection unit that is connected to the client terminal;
an identifier storage unit that records an identifier for causing the authentication server to perform authentication; and
an identifier transmission unit that automatically transmits an identifier to the authentication server via the client terminal in a state in which the connection unit is connected to the client terminal,
wherein the small terminal causes the authentication server to authenticate the client terminal on the basis of the identifier so that the client terminal accesses the target apparatus, and is attachable to and detachable from the client terminal.

11. An authentication server of a virtual network building system including a client terminal that accesses a private network via a public line, the authentication server that performs authentication on the client terminal, and a target apparatus that is disposed on the private network, the authentication server comprising:
a reception unit that receives an identifier recorded on a small terminal connected to the client terminal;
an authentication unit that performs authentication on the basis of the identifier;
a communication method selection unit that selects a communication protocol and an encryption method for communication between the client terminal and the authentication server when the authentication unit has performed the authentication;
a distribution unit that distributes software for encrypting communication to the client terminal according to the selected communication protocol and encryption method;
an encryption unit that encrypts communication with the client terminal on the basis of the selected communication protocol and encryption method;
a reception unit that receives information regarding a request for access to the target apparatus, which is automatically transmitted from the distributed software; and
a redirect unit that makes a proxy response of access of the client terminal to the target apparatus in response to the received access request information.
